(19) United States
(12) Patent Application Publication
(10) Pub. No.: US 2024/0206432 A1
(43) Pub. Date: Jun. 27, 2024

(54) Pet Barking Stopper and Control Method Thereof

(71) Applicant: Zhongshan Great-pet internationl Co., LTD, Zhongshan City Guangdong Province (CN)

(72) Inventor: Yin Lin, Zhongshan City Guangdong Province (CN)

(21) Appl. No.: 18/596,927

(22) Filed: Mar. 6, 2024

Related U.S. Application Data
(63) Continuation of application No. 17/646,461, filed on Dec. 29, 2021.

(51) Int. Cl. A01K 15/02

(52) U.S. Cl. CPC A01K 15/022

(57) ABSTRACT

A pet barking stopper comprises a conductive strap, a stopping bark assembly adjustably mounted on the conductive belt, and a soft conductive brush and a controlling circuit; the soft conductive brush is penetrated and mounted in the stopping bark assembly, and used for contacting with the body of the pet; the controlling circuit is arranged in the stopping bark assembly, and electrically coupled with the soft conductive brush and the conductive strap, and used for transmitting a pulse signal with a predetermined specific voltage to the soft conductive brush and the conductive strap, the pulse signal are conductive to the pet's body by the soft conductive brush. The pet barking stopper stops the bark of the pet without damaging the pet.

### CROSS REFERENCE TO RELATED APPLICATION

This application is a continuation of US invention application Ser. No. 17/646,461, entitled “PET BARKING STOPPER AND CONTROL METHOD” filed on Dec. 29, 2021, and the entire contents of which are incorporated herein by reference.

### FIELD OF THE INVENTION

The present disclosure relates to the technical field of pet supplies, more particularly a pet barking stopper and a control method thereof.

### BACKGROUND OF THE INVENTION

As the improvement of the living standards, the attention to the quality of pet living is also increasing. More and more people see pets as parts of their families. However, sometimes the pets cannot resist their nature, their barking bothers people's normal lives. At the same time, the hosts fall into a potential crisis complained by their neighbors. So people develop a pet barking stopper that can stop animal's bark.

At present, animal barking stopper in the market includes single vibration type barking stoppers and electric shock type barking stoppers. The single vibration type barking stopper can stop animal's bark through vibration, but this type of barking stopper does not work well. Due to the electric shock type barking stopper needs for using electric shock, a hard conductive number is generally provided to be conductive and in contact with pets, which leads to damage to the skin and the hair of pets in the daily wearing process of pet, and even leads to severe damage to the pets under a severe electric shock.

Therefore, it is necessary to develop a pet barking stopper and control method.

### SUMMARY OF THE INVENTION

The object of the present disclosure is to provide a pet barking stopper and a control method thereof to resolve the technical problem that the pet barking stopper in the prior art easily damages the pets.

In order to achieve the above object, the present disclosure provides a pet barking stopper, which includes a conductive strap, a stopping bark assembly adjustably mounted on the conductive belt, a soft conductive brush, and a controlling circuit.

The soft conductive brush is mounted in the stopping bark assembly, extends out from it, and is used for contacting with a pet's body.

The controlling circuit is provided in the stopping bark assembly and electrically coupled with the soft conductive brush and the conductive strap, and used for transmitting a pulse signal with a predetermined specific voltage to the soft conductive brush and the conductive strap, the pulse signal is conducted to the pet's body by the soft conductive brush.

Optionally, the soft conductive brush comprises a plurality of branch brush structures. Each of the branch brush structures extends out from the stopping bark assembly with a gap between the branch brush structures.

Optionally, the stopping bark assembly includes a shell and a main body. The conductive strap and the shell are activity connected, the main body is detachably mounted in the shell. The soft conductive brush extends out from the shell, the controlling circuit is mounted in the main body. The controlling circuit is electrically coupled with the soft conductive brush and the conductive strap.

Optionally, a middle of a side wall of the shell is provided with a mounting slot, two sides of the shell are provided with a connecting hole, respectively. The soft conductive brush runs through a bottom wall of the mounting slot. The main body is mounted in the mounting slot. The controlling circuit is electrically coupled with the soft conductive brush and the conductive strap. The conductive strap is connected with the connecting holes, respectively.

Optionally, the main body is magnetically connected with the mounting slot.

Optionally, an edge of the mounting slot is provided with an opening.

Optionally, the stopping bark assembly includes a shell and a main body. A middle of a side wall of the shell is provided with a mounting slot, a side wall of the mounting slot is penetrated with a clamping hole. The other side wall of the main body is provided with a start switch. The soft conductive brush runs through the side wall of the main body. The controlling circuit is mounted in the main body, the start switch is clamped with the clamped hole, the conductive strap slidably passes between the main body and the bottom of the mounting slot.

Optionally, the stopping bark assembly includes a main body portion, both sides of the main body portion are respectively penetrated to form socket holes. The controlling circuit is mounted in the main body, the soft conductive brush runs through the side wall of the main body portion and electrically coupled with the controlling circuit. The conductive strap runs through the socket holes in turn so that when the main body portion is pushed, the stopping bark assembly is sliding along the conductive strap.

Optionally, the stopping bark assembly includes a main body portion, the main body portion is penetrated to form a communicated hole. The controlling circuit is mounted in the main body, the soft conductive brush runs through the side wall of the main body portion and electrically coupled with the controlling circuit. The conductive strap runs through the communicated hole to slidably connect with the main body portion.

Optionally, the stopping bark assembly includes a mounting belt and a main body mounted on the mounting belt. Both ends of the mounting belt are respectively provided with a first connecting part and a second connecting part. After the mounting belt is wound around the conductive strap, the first connecting part and the second connecting part can be detachably connected. The controlling circuit is mounted in the main body, the soft conductive brush is mounted on the mounting belt and electrically coupled with the controlling circuit.

Optionally, the first connecting part and the second connecting part are made of Velcro.

Optionally, the controlling circuit comprises a power supply circuit and a control signal detecting circuit, a main controlling circuit and a pulse outputting circuit, all electrically connected with the power supply circuit.

The control signal detecting circuit is used for detecting a stop barking control signal.

The main controlling circuit is electrically coupled with the control signal detecting circuit and used for obtaining the stop barking control signal and generating a pulse transmitting signal according to the stop barking control signal.

The pulse outputting circuit is electrically coupled with the main controlling circuit, the soft conductive brush and the conductive belt, and used for transmitting a pulse signal with a preset specific voltage according to the pulse transmitting signal to the soft conductive brush and the conductive strap, so that the pulse signal is conducted to the pet's body through the soft conductive brush.

Optionally, the control signal detecting circuit comprises a sound detecting circuit, electrically coupled with the main controlling circuit and used for detecting the sound data about the pet's bark.

Optionally, the control signal detecting circuit comprises a wireless control receiving circuit, electrically coupled with the main controlling circuit and used for detecting a wireless remote control signal transmited by a user through via a remote control.

Optionally, the power supply circuit comprises a charging circuit and a rechargeable battery, the charging circuit is used for connecting with an external power supply device, and the rechargeable battery is electrically coupled with the charging circuit, the control signal detecting circuit, the main control circuit and the pulse outputting circuit.

One or more of the above technical solutions of the pet barking stopper provided by the embodiment in the disclosure has at least one of the following technical effects:

When the pet barking stopper in the present disclosure is used, the pet barking stopper is tied to the pet's neck by the conductive strap, the soft conductive brush in the inside of the stopping bark assembly is in contact with the pet's body. When it needs to control the pet to stop barking, the controlling circuit transmits a pulse signal with a preset specific voltage to the soft conductive brush and the conductive strap so that the pulse signal is conducted to the pet's body through the soft conductive brush and the pulse signal stimulates the pet's muscles and meridians, enabling the pet to stretch its muscles and causing the pet to stop barking. In the process, because the soft conductive brush is soft, it will not damage the pet's body in daily wearing or the stimulation of pulse signal, so as to avoid the damage to the pet in the process of stopping barking, and protect the animal itself and stop barking.

In order to achieve the above object, the present disclosure also provides a control method of the pet barking stopper, which includes the following steps:

Step 100, the pet barking stopper is tied to the pet body through the conductive strap, and the soft conductive brush is in contact with the pet body.

Step 200, the controlling circuit transmits the pulse signal with a preset specific voltage to the soft conductive brush and the conductive strap so that the pulse signal is conducted to the pet's body through the soft conductive brush and the pulse signal stimulates the pet's muscles and meridians, enabling the pet to stretch its muscles and causing the pet to stop barking.

One or more of the above technical solutions of the pet barking stopper provided by the embodiment in the disclosure has at least one of the following technical effects:

Because the control method is based on the pet barking stopper, it can control the pet to stop bark by stretching pet's muscles under the stimulation of the pulse signal. In the process, because the soft conductive brush is soft, it will not damage the pet's body in daily wearing or the stimulation of pulse signal, so as to avoid the damage to the pet in the process of stopping barking, and protect the animal itself and stop barking.

### BRIEF DESCRIPTION OF THE DRAWINGS

In order to more clearly illustrate the technical schemes in the embodiments in the present disclosure, the drawings needed in the embodiments or the prior technical description are briefly introduced below. Obviously, the drawings described below are only some embodiments in the present disclosure, and for those skilled in the art, additional drawings may be obtained according to the drawings below without creative work.

FIG. 1 is a perspective view of the pet barking stopper according to the embodiment in the present disclosure.

FIG. 2 is a perspective view of the pet barking stopper removing part of the conductive strap according to the embodiment in the present disclosure.

FIG. 3 is a decomposition view of the stopping bark assembly of pet barking stopper according to the embodiment in the present disclosure.

FIG. 4 is the other perspective view of the pet barking stopper removing part of the conductive strap according to the embodiment in the present disclosure.

FIG. 5 is a decomposition view of FIG. 4.

FIG. 6 is another perspective view of the pet barking stopper removing part of the conductive strap according to the embodiment in the present disclosure.

FIG. 7 is the other perspective view of the pet barking stopper according to the embodiment in the present disclosure.

FIG. 8 is another perspective view of the pet barking stopper according to the embodiment in the present disclosure.

FIG. 9 is a circuit configuration diagram of the controlling circuit according to the embodiment in the present disclosure.

FIG. 10 is a flowchart of a control method of the pet barking stopper according to the embodiment in the present disclosure.

### DETAILED DESCRIPTION OF ILLUSTRATED EMBODIMENTS

In order to make the disclosure purpose, the technical scheme and the technical effect more clearly be understood, the disclosure is further explained in combination with the concrete embodiment below. It should be understood that the specific embodiments described herein are only used to interpret the disclosure and are not used to limit the disclosure.

Embodiments of the present disclosure are described in detail below, and examples of the embodiments are shown in the attached drawings, in which the same or similar labels represent the same or similar elements or elements with the same or similar function. The embodiments described below by reference to the attached drawings are exemplary and are intended to explain embodiments of the present disclosure and cannot be understood as limits in the present disclosure.

In the description of the embodiments of the present disclosure, it should be understood that the directional indications involved in the embodiments, such as the “upper”, “lower”, “left”, “right”, “front”, “rear”, “internal” and “external”, indicating orientation or location relationship, are based on the orientation or position relationship showed in the figures. These directional indications are only for describing the embodiments in the present disclosure and simplifying the description, rather than indicating or implying that the device or the element must be constructed and operated in a specified azimuth, which cannot be understood as a limitation of the present disclosure.

Further, the terms “first”, and “second” are used only for description purposes, and cannot be understood as indicating or implying relative importance or implicitly indicating the number of technical features indicated. Thus, features defining “first” and “second” May expressly or implicitly include one or more of the features. In the description of the embodiments of the present disclosure, the “plurality of ” means two or more unless otherwise specifically limits.

In the embodiments of the disclosure, unless otherwise clearly specified and defined, the terms, “installed”, “connected”, “or “fixed” should be generally understood, for example, a fixed connection, or a removable connection, a mechanical connection or an electrical connection, or a direct connection or an indirect connection through an intermediate media, or a connection within two elements or the interaction of two elements. For those of ordinary skilled in the art, the specific meaning of the above terms in the embodiment of the present disclosure may be understood under specific circumstances.

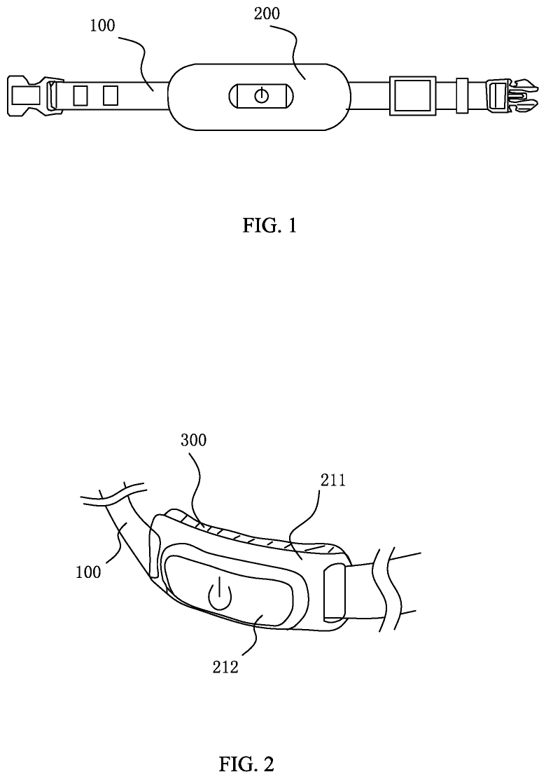

In an embodiment according to the present disclosure, referring to FIG. 1-FIG. 9, a pet barking stopper includes a conductive strap 100, a stopping bark assembly 200 adjustably mounted on the conductive belt 100. The position of the stopping bark assembly 200 mounted on the conductive strap 100 can be adjusted as desired, which is convenient.

The pet barking stopper also includes a soft conductive brush 300 and a controlling circuit 400. The soft conductive brush 300 is mounted in the stopping bark assembly 200 and extends out from it, and is used for contact with the body of the pet. The controlling circuit 400 is arranged in the stopping bark assembly 200, and electrically coupled with the soft conductive brush 300 and the conductive strap 100, and used for transmitting a pulse signal with a predetermined specific voltage to the soft conductive brush 300 and the conductive strap 100, the pulse signal is conducted to the pet's body by the soft conductive brush 300.

When the pet barking stopper in the present disclosure is used, the pet barking stopper is tied to the pet's neck by the conductive strap 100, the soft conductive brush 300 is in contact with the pet's body. When it needs to control a pet to stop barking, the controlling circuit 400 transmits the pulse signal with a preset specific voltage to the soft conductive brush 300 and the conductive strap 100 so that the pulse signal is conducted to the pet's body through the soft conductive brush 300, and the pulse signal stimulates the pet's muscles and meridians, enabling the pet's muscles to stretch and causing the pet to stop barking. In the process, because the soft conductive brush 300 is soft, it will not damage the pet's body in daily wearing or the stimulation of pulse signal, so as to avoid the damage to the pet in the process of stopping barking and protecting the pet.

In an embodiment according to the present disclosure, the controlling circuit 400 transmits two pulse signals to the conductive strap 100 and the soft conductive brush 300, respectively. The conductive wires of the conductive strap 100 and the soft conductive brush 300 do not interfere with each other so that the pet barking stopper can still stop barking normally after one of them is damaged.

In an embodiment according to the present disclosure, the conductive strap 100 includes a cloth and a conductive carbon fiber arranged in the cloth and connected with the output terminal of the controlling circuit 400.

In an embodiment according to the present disclosure, the outer surface of the conductive strap 100 is coated with a conductive coating connecting with an output terminal of the controlling circuit 400.

In an embodiment according to the present disclosure, the range value of the preset specific voltage is 50V-500V, and the range value of the output current is a small current of 0-15 mA, which realizes the output of large voltage and small current, and then realizes the non-destructive stopping bark of pets. The pulse signal, based on the output of large voltage and small current, stimulates the pet's muscles and meridians, which can avoid strength pulse signals to damage the pet's body and mental. When a weak electric pulse signals stimulates the pet's muscles and meridians, and the pet's muscles stretches, which will not cause pet's muscles hurt and achieve a similar effect of benign muscle bundle fibrillation but does not damage the pet, thus the object of the non-destructive stopping bark of pet can be realized.

Further, corresponding to different categories and different volumes of pets, different voltage range values can be set, and small currents can be set at the same time, so as to realize stop barking for different pets.

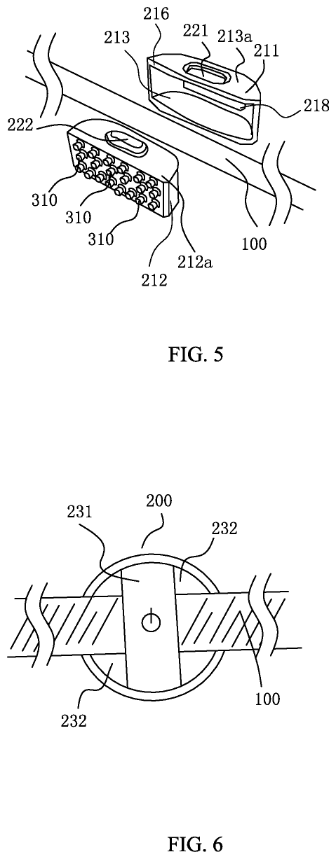

In an embodiment according to the present disclosure, referring to FIG. 4 and FIG. 5, the soft conductive brush 300 comprises a plurality of branch brush structures 310. Each of the branch brush structures 310 runs through the stopping bark assembly 200 with a gap between the branch brush structures. Specifically, each of the branch brush structures 310 is in a bundle shape and is formed by the aggregation of a plurality of conductive carbon fibers so that the branch brush structures 310 can stimulate a plurality of body areas of the pet at the same time when conducting pulse signals, so as to improve the stopping bark effect.

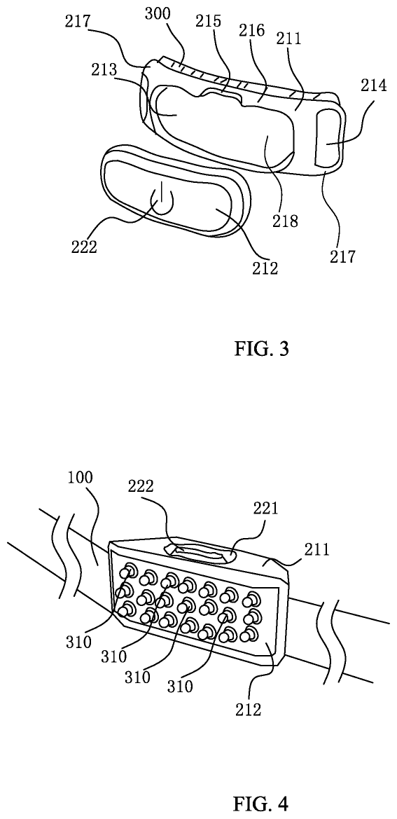

In an embodiment according to the present disclosure, referring to FIG. 2 and FIG. 3, the soft conductive brush 300 is integral and covers the inner area of the stopping bark assembly 200. In this way, the contact area between the soft conductive brush 300 and the pet is enhanced to the greatest extent, the pet is stimulated to the greatest extent, and the bark stopping effect is improved.

In an embodiment according to the present disclosure, referring to FIG. 1, FIG. 2 and FIG. 3, the stopping bark assembly 200 includes a shell 211 and a main body 212. The conductive strap 100 and the shell 211 is activity connected, the main body 212 is detachably mounted in the shell 211. The soft conductive brush 300 runs through the shell 211, and the controlling circuit 400 is mounted in the main body. The controlling circuit 400 is electrically coupled with the soft conductive brush 300. The shell 211 plays the role of protecting the main body 212. And the main body 212 is detachably mounted in the shell 211 to facilitate assembly and disassembly.

Specifically, a middle of an side wall 216 of the shell 211 is provided with a mounting slot 213, two sides 217 of the shell 211 are provided with a connecting hole 214, respectively. The soft conductive brush 300 runs through a bottom wall 218 of the mounting slot 213. The main body 212 is mounted in the mounting slot 213. The controlling circuit 400 is electrically coupled with the soft conductive brush 300. The conductive strap 100 is connected with the connecting holes 214 respectively. The mounting slot 213 plays a role of facilitating the installation of the main body 212. The two connecting holes 214 can be conveniently and quickly connected by the conductive strap 100.

In an embodiment according to the present disclosure, the main body 212 is magnetically connected with the mounting slot 213. That is to say, the main body 212 and the mounting slot 213 are respectively provided with mutually attractive magnetic suction parts, so that there is no need for redundant snap structure, the installation is convenient and fast, and the cost is saved.

In an embodiment according to the present disclosure, referring to FIG. 3, the edge of the mounting slot 213 is provided with an opening 215. When it needs to remove the main body 212 from the mounting slot 213, a finger inserts into the notch 215 to remove it, which is convenient and fast.

In an embodiment according to the present disclosure, referring to FIG. 4 and FIG. 5, the stopping bark assembly 200 includes a shell 211 and a main body 212. A middle of a side wall 26 of the shell 211 is provided with the mounting slot 213, a side wall 213a of the mounting slot 213 is penetrated with a clamping hole 221.

A side wall 212a of the main body 212 is provided with a start switch 222 electrically coupled with the controlling circuit 400. Press the start switch 222, the controlling circuit 400 starts work.

The soft conductive brush 300 extends out from the main body 212. The controlling circuit 400 is mounted in the main body 212 and is electrically coupled with the soft conductive brush 300. The main body 212 is mounted in the mounting slot 213, and the start switch 222 is clamped in the clamping hole 221. The conductive strap 100 slidably passes between the main body 212 and the bottom surface 218 of the mounting slot 213. Specifically, with these structures, it can achieve that when the main body 212 is pushed, it can slid along the conductive strap 100 so as to adjust its position on the conductive strap 100.

In an embodiment according to the present disclosure, referring to FIG. 6, the stopping bark assembly 200 includes a main body portion 231, both sides of the main body portion 231 are respectively provided with a socket holes 232. The controlling circuit 400 is mounted in the main body 231, the soft conductive brush 300 extends out from the main body portion 231 and electrically coupled with the controlling circuit 400. The conductive strap 400 runs through the socket holes 232 in turn so that when the main body portion 231 is pushed, the stopping bark assembly 200 is sliding along the conductive strap 100. In the embodiment, the stopping bark assembly 200 is arranged as a whole, and the rapid assembly of the stopping bark assembly 200 and the conductive strap 100 is realized through the socket holes 232.

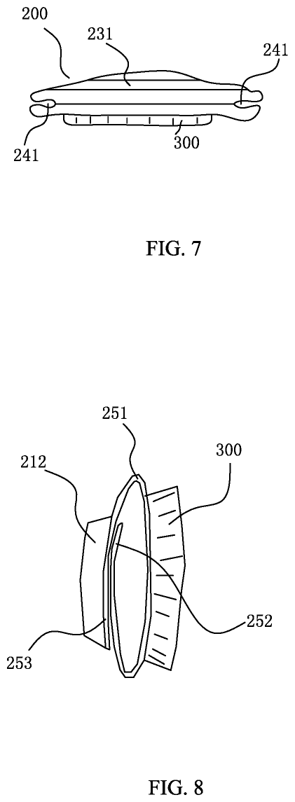

In an embodiment according to the present disclosure, referring to FIG. 7, the stopping bark assembly 200 includes a main body portion 231, the main body portion 231 is penetrated to form two communicated holes 241. The controlling circuit 400 is mounted in the main body 231, the soft conductive brush 300 extends out from the main body portion 231 and electrically coupled with the controlling circuit 400. The conductive strap 100 runs through the communicated holes 241 to slidably connect with the main body portion 231. The conductive strap 100 can slide along the communicated holes 241, and the communicated holes 241 are flat to match the conductive strap 100.

In an embodiment according to the present disclosure, referring to FIG. 8, the stopping bark assembly 200 includes a mounting belt 251 and a main body 212 mounted on the mounting belt 251. Both ends of the mounting belt 251 is respectively provided with a first connecting part 252 and a second connecting part 253. After the mounting belt 251 is wound around the conductive strap 100, the first connecting part 252 and the second connecting part 253 can be detachably connected. The controlling circuit 400 is mounted in the main body 212, the soft conductive brush 300 is mounted on the out side of the mounting belt 251 and electrically coupled with the controlling circuit 400. In the embodiment, the first connecting part 252 and the second connecting part 253 can help tie the pet barking stopper on the pet's body, for example neck, quickly.

Specifically, the first connecting part 252 and the second connecting part 253 are made of Velcro, which can realize assemble and disassemble without other adhesive.

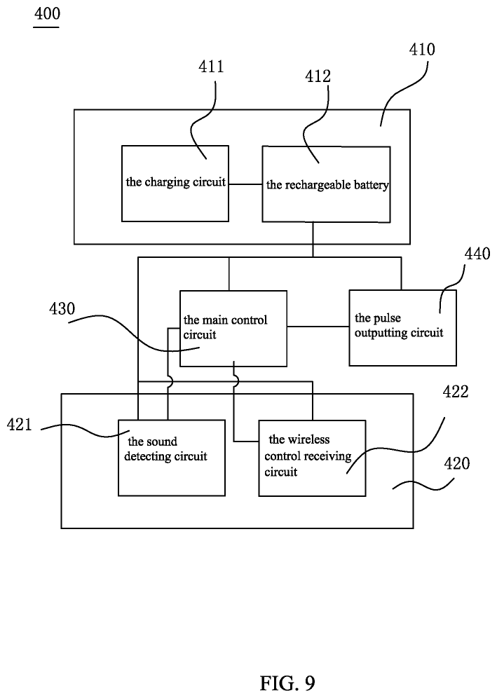

In an embodiment according to the present disclosure, referring to FIG. 9, the controlling circuit 400 comprises a power supply circuit 410 and a control signal detecting circuit 420, a main controlling circuit 430 and a pulse outputting circuit 440, all electrically connected with the power supply circuit 410.

The control signal detecting circuit is used for detecting a stop barking control signal, comprising wireless remote control signals and barking sound data for pets.

The main controlling circuit 430 is electrically coupled with the control signal detecting circuit 420 and is used for obtaining the stop barking control signal and generate a pulse transmitting signal according to the stop barking control signal.

The pulse outputting circuit 440 is electrically coupled with the main controlling circuit 430, the soft conductive brush 300 and the conductive belt 100, and is used for transmitting the pulse signal with the preset specific voltage according to the pulse transmitting signal to the soft conductive brush 300 and the conductive strap 100, so that the pulse signal is conducted to the pet's body through the soft conductive brush 300.

In an embodiment according to the present disclosure, the control signal detecting circuit comprises a sound detecting circuit 421, electrically coupled with the main controlling circuit 430 and used for detecting the sound data about pet's bark sound. Specifically, when the controlling circuit 400 starts, the sound detecting circuit 421 collects barking sound data from pets in real time, when the bark sound of the pet is too loud, the main controlling circuit 430 generates pulse transmitting signal and sends it to the pulse outputting circuit 440, thereby realizing to stop barking.

In an embodiment according to the present disclosure, referring to FIG. 9, the control signal detecting circuit comprises a wireless control receiving circuit 422, electrically coupled with the main controlling circuit 430 and used for collecting a wireless remote control signal transmitted by a user through a remote controller. The wireless control receiving circuit includes, but is not limited to, a module circuit composed of a Bluetooth, a WiFi, and a 2.4 GHZ transmitter. In this way, the pet barking stopper can be controlled remotely, the convenience of use is improved

In an embodiment according to the present disclosure, referring to FIG. 9, the power supply circuit 410 comprises a charging circuit 411 and a rechargeable battery 412, the charging circuit 411 is used for connecting with an external power supply device, and the rechargeable battery 412 is electrically coupled with the charging circuit 411, the control signal detecting circuit 420, the main control circuit 430 and the pulse outputting circuit 440. The charging circuit 411 is used for managing the electrical energy outputting by the external power supply devices, simultaneously protecting the rechargeable battery 412 and avoiding overcharge and discharge problem, which improves the stability and safety of the electric control part of the pet barking stopper.

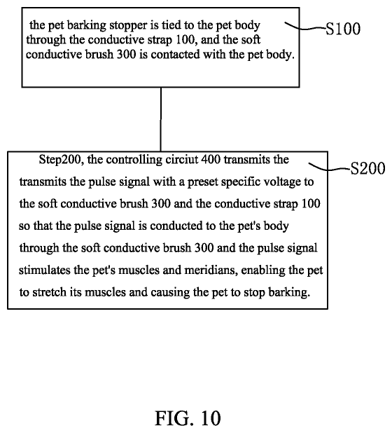

In an embodiment according to the present disclosure, referring to FIG. 10, the present disclosure also provide a a control method of the pet barking stopper, which includes the following steps:

Step 100: the pet barking stopper is tied to the pet body through the conductive strap 100, and the soft conductive brush 300 is in contact with the pet body.

Step 200, the controlling circuit 400 transmits the pulse signal with a preset specific voltage to the soft conductive brush 300 and the conductive strap 100 so that the pulse signal is conducted to the pet's body through the soft conductive brush 300 and the pulse signal stimulates the pet's muscles and meridians, enabling the pet to stretch its muscles and causing the pet to stop barking.

Wherein, the range value of the preset specific voltage is 50V-500V, and the range value of the output current is a small current of 0-15 mA, which realizes the output of large voltage and small current, and then realize the non-destructive stopping bark of pets

Further, corresponding to different categories and different volumes of pets, different voltage range values can be set, and small currents can be set at the same time, so as to realize stop barking for different pets.

Because the control method is based on the pet barking stopper, it can achieve to control the pet to stop bark by stretching pet's muscles under the stimulation to pet. In the process, because the soft conductive brush 300 is soft, it will not damage the pet's body in daily wearing or the stimulation of pulse signal, so as to avoid the damage to the pet in the process of stopping barking, and protect the animal itself and stop barking.

The above are only better embodiments of the disclosure and are not used to limit the disclosure, and any modifications, equivalent replacements, and improvements made within the spirit and principles of the disclosure shall be included within the protection of the disclosure.

What is claimed is:

1. A pet barking stopper, comprising a conductive strap, a stopping bark assembly adjustably mounted on said conductive belt, wherein also comprising:
a soft conductive brush, mounted in said stopping bark assembly and extends out from it, used for contacting with said body of said pet;
a controlling circuit, mounted in said stopping bark assembly, and electrically coupled with said soft conductive brush and said conductive strap, and used for transmitting a pulse signal with a predetermined specific voltage to said soft conductive brush and said conductive strap, said pulse signal are conductive to said pet's body by said soft conductive brush.

2. The pet barking stopper according to claim 1, wherein said soft conductive brush comprises a plurality of branch brush structures, each of said branch brush structures runs through said stopping bark assembly with a gap between said branch brush structures.

3. The pet barking stopper according to claim 1, wherein said soft conductive brush is integral and covers a side wall of said stopping bark assembly.

4. The pet barking stopper according to claim 1, wherein said stopping bark assembly includes a shell and a main body; said conductive strap and said shell is activity connected, said main body is detachably mounted in said shell; said soft conductive brush runs through said shell, said controlling circuit is mounted in said main body; said controlling circuit is electrically coupled with said soft conductive brush and said conductive strap.

5. The pet barking stopper according to claim 2, wherein said stopping bark assembly includes a shell and a main body; said conductive strap and said shell is activity connected, said main body is detachably mounted in said shell; said soft conductive brush runs through said shell, said controlling circuit is mounted in said main body; said controlling circuit is electrically coupled with said soft conductive brush and said conductive strap.

6. The pet barking stopper according to claim 3, wherein a middle of a side wall of said shell is provided with a mounting slot, two sides of said shell are provided with a connecting hole, respectively; said soft conductive brush runs through a bottom surface of said mounting slot; said main body is mounted in said mounting slot; said controlling circuit is electrically coupled with said soft conductive brush and said conductive strap; said conductive strap is connected with said connecting holes, respectively.

7. The pet barking stopper according to claim 1, wherein said stopping bark assembly includes a shell and a main body; a middle of a side wall of said shell is provided with a mounting slot, a side wall of said mounting slot is penetrated with a clamping hole; a side wall of said main body is provided with a start switch; said soft conductive brush runs through said said side wall of said main body; said controlling circuit is mounted in said main body, said start switch is clamped with said clamped hole, said conductive strap slidably passes between said main body and said bottom of said mounting slot.

8. The pet barking stopper according to claim 2, wherein said stopping bark assembly includes a shell and a main body; a middle of a side wall of said shell is provided with a mounting slot, a side wall of said mounting slot is penetrated with a clamping hole; a side wall of said main body is provided with a start switch; said soft conductive brush runs through said said side wall of said main body; said controlling circuit is mounted in said main body, said start switch is clamped with said clamped hole, said conductive strap slidably passes between said main body and said bottom of said mounting slot.

9. The pet barking stopper according to claim 1, wherein said stopping bark assembly includes a main body portion, both sides of said main body portion are respectively penetrated to form socket holes; said controlling circuit is mounted in said main body, said soft conductive brush runs through said main body portion and electrically coupled with said controlling circuit; said conductive strap runs through said socket holes in turn so that when said main body portion is pushed, said stopping bark assembly is sliding along said conductive strap.

10. The pet barking stopper according to claim 2, wherein said stopping bark assembly includes a main body portion, both sides of said main body portion are respectively penetrated to form socket holes; said controlling circuit is mounted in said main body, said soft conductive brush runs through said main body portion and electrically coupled with said controlling circuit; said conductive strap runs through said socket holes in turn so that when said main body portion is pushed, said stopping bark assembly is sliding along said conductive strap.

11. The pet barking stopper according to claim 1, wherein said stopping bark assembly includes a main body portion, said main body portion is penetrated to form a communicated hole; said controlling circuit is mounted in said main body, said soft conductive brush runs through said main body portion and electrically coupled with said controlling circuit; said conductive strap runs through said communicated hole to slidably connect with said main body portion.

12. The pet barking stopper according to claim 2, wherein said stopping bark assembly includes a main body portion, said main body portion is penetrated to form a communicated hole; said controlling circuit is mounted in said main body, said soft conductive brush runs through said main body portion and electrically coupled with said controlling circuit; said conductive strap runs through said communicated hole to slidably connect with said main body portion.

13. The pet barking stopper according to claim 1, wherein said stopping bark assembly includes a mounting belt and a main body mounted on said mounting belt; two ends of said mounting belt is respectively provided with a first connecting part and a second connecting part; after said mounting belt is wound around said conductive belt, said first connecting part and said second connecting part can be detachably connected; said controlling circuit is mounted in said main body, said soft conductive brush is mounted on said mounting belt and electrically coupled with said controlling circuit; said first connecting part and said second connecting part are made of Velcro.

14. The pet barking stopper according to claim 1, wherein said controlling circuit comprises a power supply circuit and a control signal detecting circuit, a main controlling circuit and a pulse outputting circuit, all electrically connected with said power supply circuit;
said control signal detecting circuit is used for detecting a stop barking control signal;
said main controlling circuit is electrically coupled with said control signal detecting circuit and is used for obtaining said stop barking control signal and generate a pulse transmitting signal according to said stop barking control signal;
said pulse outputting circuit is electrically coupled with said main controlling circuit, said soft conductive brush and said conductive belt, and is used for transmitting a pulse signal with a preset specific voltage according to said pulse transmitting signal to said soft conductive brush and said conductive strap, so that said pulse signal is conducted to said pet's body through said soft conductive brush.

15. A control method of said pet barking stopper according to claim 1, wherein comprising following steps:
step 100, said pet barking stopper is tied to said pet body through said conductive strap, and said soft conductive brush is in contact with said pet body;
step 200, said controlling circuit transmits said transmits said pulse signal with a preset specific voltage to said soft conductive brush and said conductive strap so that said pulse signal is conducted to said pet's body through said soft conductive brush and said pulse signal stimulates said pet's muscles and meridians, enabling said pet to stretch its muscles and causing the pet to stop barking.
